(19) United States
(12) Patent Application Publication
(10) Pub. No.: US 2005/0024664 A1
(43) Pub. Date: Feb. 3, 2005

(54) Printer formatter with print server

(76) Inventor: William Randolph Schmidt, Boise, ID (US)

Correspondence Address: AGILENT TECHNOLOGIES, INC.;Legal Department, DL429, Intellectual Property Administration, P.O. Box 7599, Loveland, CO, 80537-0599, US

(21) Appl. No.: 10/630,419

(22) Filed: Jul. 30, 2003

(51) Int. Cl. G06F 15/00

(52) U.S. Cl. 358/1.13; 358/1.15

(57) ABSTRACT

A printer formatter comprising a processing system, a system input/output (I/O) coupled to the processing system, a formatter control, and a print server is provided. The processing system is configured to perform a first function associated with the system I/O, perform a second function associated with the print server, and perform a third function associated with the formatter control.

### FIELD OF THE INVENTION

The present invention generally relates to printers, and more particularly, to a printer formatter with a print server.

### BACKGROUND OF THE INVENTION

In a networked computer system environment, it is often desirable to provide users of computer systems in the network with access to a printer. A print server is typically employed to manage the access of multiple users to the printer.

A print server may be implemented on a computer system that is connected to a printer. In such a system, users from other computer systems can print to the printer by communicating with the print server computer system. For a user to be able to print, however, the print server computer system needs to be powered on and running. If the print server computer system is not powered on or running, then a user may not be able to print to the printer.

A print server may also be implemented as a stand-alone device or as an add-in card to a printer. Although these components may provide users with continuous access to a printer, the components are typically purchased separately from a printer and can increase the costs of providing printer access to a network of computer systems. In addition, these components may need to be configured by a technician to operate properly with the network.

It would be desirable to be able to provide continuous printer access to a network of computer systems while minimizing the cost and complexity associated with such a system.

### SUMMARY OF THE INVENTION

The present disclosure provides a printer formatter comprising a processing system, a system input/output (I/O) coupled to the processing system, a formatter control, and a print server. The processing system is configured to perform a first function associated with the system I/O, perform a second function associated with the print server, and perform a third function associated with the formatter control.

### BRIEF DESCRIPTION OF THE DRAWINGS

FIG. 1 is a diagram illustrating an embodiment of a processing system.

FIG. 2 is a diagram illustrating an embodiment of a printer including a formatter with a print server.

FIG. 3 is a flow chart illustrating an embodiment of a method for operating a printer formatter.

### DETAILED DESCRIPTION

In the following detailed description of the preferred embodiments, reference is made to the accompanying drawings which form a part hereof, and in which is shown by way of illustration specific embodiments in which the invention may be practiced. It is to be understood that other embodiments may be utilized and structural or logical changes may be made without departing from the scope of the present invention. The following detailed description, therefore, is not to be taken in a limiting sense, and the scope of the present invention is defined by the appended claims.

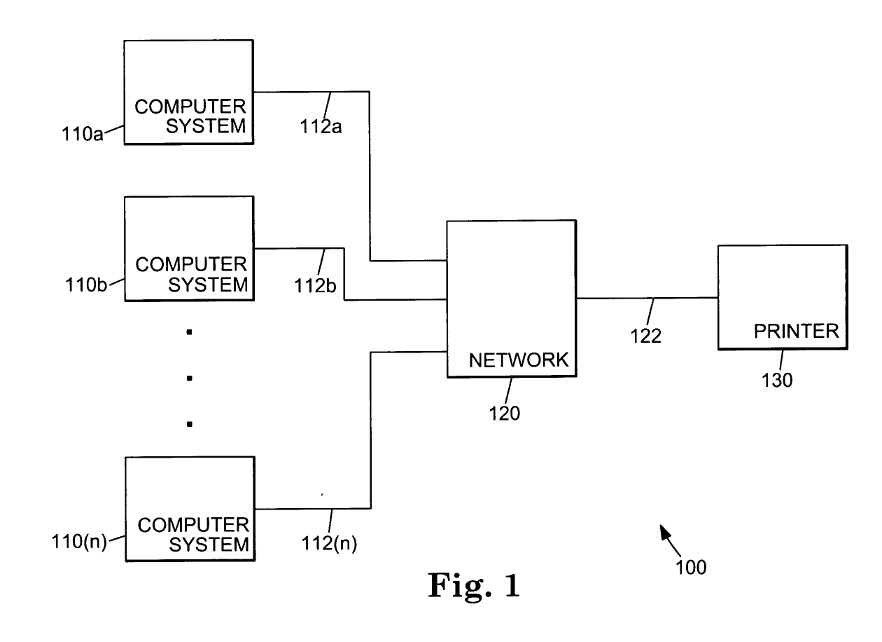

FIG. 1 is a diagram illustrating an embodiment of a processing system 100. Processing system 100 includes computer systems 110a through 110(n) where n is an integer greater than or equal to one. Computer systems 110 are coupled to a network device 120 using connections 112a through 112(n). Each connection 112 may be any type of wired or wireless connection. A printer 130 with an embedded print server (not shown in FIG. 1) is coupled to network 120 using a connection 122. Connection 122 may be any type of wired or wireless connection such as a 10/100 (Ethernet) connection, a Universal Serial Bus (USB) connection, and a parallel connection.

Computer systems 110 may each be any type of information processing system configured to generate print jobs. Examples of computer systems 110 include personal computers, laptop computers, server computers, personal digital assistants (PDAs), digital cameras and recorders, and mobile telephones. Network 120 may include any type or combination of network devices such as a router, a switch, and a hub. In other embodiments, network 120 may be omitted and computer systems 110 may couple directly to printer 130.

Printer 130 may be any type of printer configured to generate printed documents in response to print jobs received from computer systems 110. Printer 130 may be an inkjet printer or a laser printer, for example.

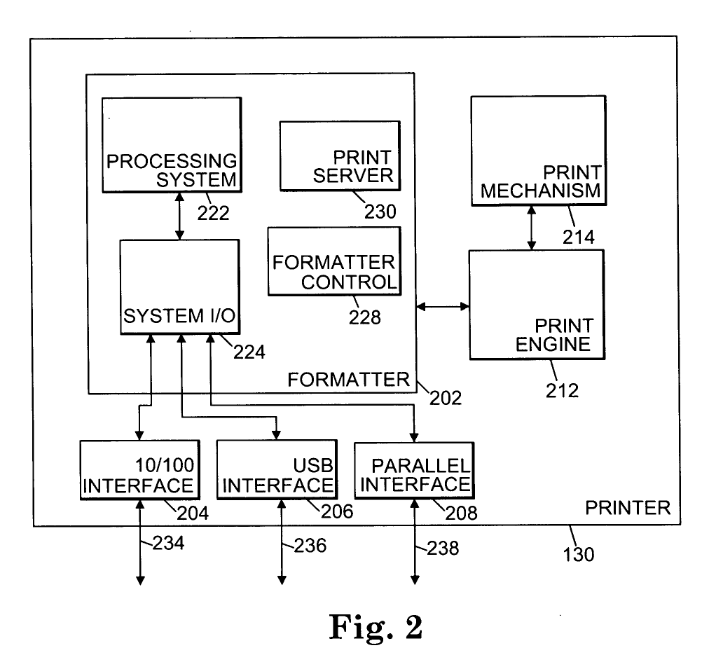

FIG. 2 is a diagram illustrating an embodiment of printer 130. Printer 130 includes a formatter 202, a 10/100 (Ethernet) interface 204, a Universal Serial Bus (USB) interface 206, a parallel interface 208, a print engine 212, and a print mechanism 214. Formatter 202 includes a processing system 222, a system input/output (I/O) 224, a formatter control 228, and a print server 230.

One or more of interfaces 204, 206, and 208 may be used to communicate with network 120 and/or computer systems 110. 10/100 interface 204 communicates with network 120 using a 10/100 connection 234, USB interface 206 communicates with network 120 using a USB connection 236, and parallel interface 208 communicates with network 120 using a parallel connection 238. In other embodiments, one or more of interfaces 204, 206, and 208 may be omitted or replaced with other types of wired or wireless interfaces.

Processing system 222 is configured to perform functions associated with system I/O 224, formatter control 228, and print server 230. System I/O 224, formatter control 228, and print server 230 may each comprise hardware components, software components, or a combination of hardware and software components. In one particular embodiment, formatter 202 comprises a single microchip, i.e., processing system 222, system I/O 224, formatter control 228, and print server 230 are manufactured on a common substrate such as silicon. In embodiments where system I/O 224, formatter control 228, and/or print server 230 each include at least one software component, processing system 222 may execute instructions from the software components to cause functions to be performed.

System I/O 224 is configured to receive print jobs from computer systems 110 across network 120 using an interface 204, 206, and/or 208. System I/O 224 manages interfaces 204, 206, and 208 and notifies processing system 222 in response to print jobs being received on one or more of interfaces 204, 206, or 208.

Print server 230 detects the print jobs received from computer systems 110. In response to detecting that a print job has been received, print server 230 stores the print job in a print queue and periodically notifies the computer system 110 of the status of the print job. Printer server 230 also removes a print job from the queue in response to a cancel request associated with the print job from a computer system 110.

Formatter control 228 accesses print jobs from the print queue and causes the print jobs to be printed using printer engine 212 and print mechanism 214. Formatter control 228 processes print jobs by converting the print jobs from the format received from a computer system 110 to a format usable by print engine 212. Formatter control 228 provides the converted print jobs to print engine 212 to cause the print jobs to be printed using print mechanism 214. Formatter 228 may also cause print jobs to be compressed and decompressed prior to being printed.

In response to a print job completing or an error occurring, print server 230 notifies the computer system 110 that its print job has either completed or an error has occurred.

Print engine 212 receives a print job in a format generated by formatter 202 and causes print mechanism 214 to form images on a recording medium. Print mechanism 214 may comprise a laser print mechanism, an inkjet print mechanism, or any other type of print mechanism. In embodiments where print mechanism 214 comprises a laser print mechanism, print mechanism 214 may include a laser and a rotatable drum. In embodiments where print mechanism 214 comprises an inkjet print mechanism, print mechanism 214 may include one or more print heads mounted on a shuttle carriage.

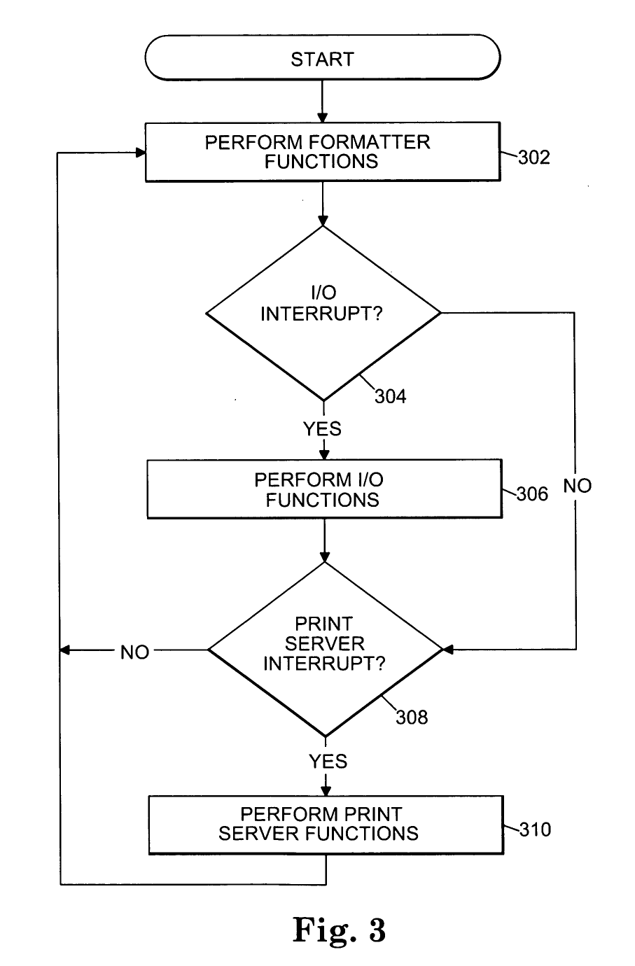

FIG. 3 is a flow chart illustrating an embodiment of a method for operating a formatter 202. In the embodiment of FIG. 3, formatter 202 performs formatter functions from formatter control 228 using processing system 222 as indicated in a block 302. Formatter functions may include accessing a print job from a queue, converting a print job from a received format to a format useable by print engine 212, and compressing or decompressing a print job.

A determination is made by processing system 222 as to whether an I/O interrupt has been received from system I/O 224 as indicated in a block 304. For example, system I/O 224 may generate an I/O interrupt in response to receiving a print job from a computer system 110 and may provides the I/O interrupt to processing system 222. If an I/O interrupt has been received from system I/O 224, then processing system 222 performs I/O functions associated with the I/O interrupt as indicated in a block 306. I/O functions may include receiving and storing a print job, receiving other information from computer systems 110, providing status information to computer systems 110, and providing an indication to print server 230 that a print job has arrived.

If an I/O interrupt has not been received from system I/O 224, then a determination is made as to whether a print server interrupt has been received from print server 230 as indicated in a block 308. For example, printer server 230 may generate a print server interrupt in response to detecting that a print job has been received by printer 130. If a print server interrupt has been received from print server 230, then processing system 222 performs print server functions associated with the print server interrupt as indicated in a block 310. Print server functions may include storing a print job in a queue, notifying a computer system 110 of a status of a print job, and removing a print job from a queue in response to a cancel signal from a computer system 110.

If a print server interrupt has not been received from print server 230, then the function of block 302 is repeated at a later time. The function of block 302 is also repeated at a later time subsequent to the function of block 310 being performed.

Although specific embodiments have been illustrated and described herein for purposes of description of the preferred embodiment, it will be appreciated by those of ordinary skill in the art that a wide variety of alternate and/or equivalent implementations calculated to achieve the same purposes may be substituted for the specific embodiments shown and described without departing from the scope of the present invention. Those with skill in the chemical, mechanical, electromechanical, electrical, and computer arts will readily appreciate that the present invention may be implemented in a very wide variety of embodiments. This application is intended to cover any adaptations or variations of the preferred embodiments discussed herein. Therefore, it is manifestly intended that this invention be limited only by the claims and the equivalents thereof.

1. A printer formatter comprising:
a processing system;
a system input/output (I/O) coupled to the processing system;
a formatter control; and
a print server; and
wherein the processing system is configured to perform a first function associated with the system I/O, wherein the processing system is configured to perform a second function associated with the print server, and wherein the processing system is configured to perform a third function associated with the formatter control.

2. The printer formatter of claim 1 wherein the first function comprises receiving a print job, wherein the second function comprises adding the print job to a queue, and wherein the third function comprises processing the print job.

3. The printer formatter of claim 2 wherein processing system is configured to cause the print job to be converted from a first format to a second format in response to processing the print job.

4. The printer formatter of claim 3 wherein the processing system is configured to provide the print job in the second format to a print engine.

5. The printer formatter of claim 1 wherein the second function comprises generating status information associated with a print job, and wherein the first function comprises providing the status information to a computer system.

6. The printer formatter of claim 1 wherein the first function comprises receiving a cancel request from a computer system, and wherein the second function comprises removing a print job associated with the cancel request from a queue.

7. The printer formatter of claim 1 wherein the system I/O is configured to communicate with a plurality of interfaces.

8. A printer comprising:
a formatter that includes a processing system, formatter control, a print server, and a system input/output (I/O);
a print engine coupled to the formatter; and
a print mechanism coupled to the print engine;
wherein the formatter is configured to perform a first function associated with the system I/O, wherein the formatter is configured to perform a second function associated with the print server, and wherein the formatter is configured to perform a third function associated with the formatter control.

9. The printer of claim 8 wherein the first function comprises receiving a print job, wherein the second function comprises adding the print job to a queue, and wherein the third function comprises processing the print job.

10. The printer of claim 8 wherein the print mechanism comprises a laser print mechanism.

11. The printer of claim 8 wherein the print mechanism comprises an ink-jet print mechanism.

12. The printer of claim 8 further comprising:
an interface configured to communicate with a network device.

13. The printer of claim 12 wherein the interface comprises a 10/100 interface.

14. The printer of claim 12 wherein the interface comprises a Universal Serial Bus (USB) interface.

15. The printer of claim 12 wherein the interface comprises a parallel interface.

16. A method performed by a printer formatter that comprises a system I/O, a formatter control, and a print server a comprising:
performing a first function associated with the system I/O;
performing a second function associated with the print server, and
performing a third function associated with the formatter control.

17. The method of claim 16 further comprising:
performing the first function by receiving a print job;
performing the second function by adding the print job to a queue; and
performing the third function by processing the print job.

18. The method of claim 16 further comprising:
performing the second function by generating status information associated with a print job; and
performing the first function by providing the status information to a computer system.

19. The method of claim 16 further comprising:
performing the second function by executing one or more instructions associated with the second function.

20. The method of claim 16 further comprising:
performing the third function by providing a print job to a print engine.
